(19) United States
(12) Patent Application Publication
(10) Pub. No.: US 2026/0057662 A1
(43) Pub. Date: Feb. 26, 2026

(54) ADAPTIVE UPDATE OF NEURAL NETWORK MODEL FOR OBJECT RE-IDENTIFICATION

(71) Applicant: HANWHA VISION CO., LTD., Seongnam-si (KR)

(72) Inventors: Changho SONG, Seongnam-si (KR); Hyunhak SHIN, Seongnam-si (KR); Sung Yeon PARK, Seongnam-si (KR); Jinook HUR, Seongnam-si (KR)

(73) Assignee: HANWHA VISION CO., LTD., Seongnam-si (KR)

(21) Appl. No.: 19/377,381

(22) Filed: Nov. 3, 2025

Related U.S. Application Data
(63) Continuation of application No. PCT/KR2024/004601, filed on Apr. 8, 2024.

(30) Foreign Application Priority Data
May 3, 2023 (KR) 10-2023-0057489

(51) Int. Cl. G06V 10/82; G06N 3/0499; G06N 3/08; H04N 23/90

(52) U.S. Cl. CPC G06V 10/82; G06N 3/0499; G06N 3/08; H04N 23/90

(57) ABSTRACT

A method for updating a neural network model for object re-identification includes: storing a neural network model pre-trained for object re-identification; acquiring images from a surveillance camera device; detecting objects from the images and, obtaining training data from among the objects to update the neural network model according to a predetermined criterion; and inputting the training data to the neural network model in a feedforward manner to obtain image characteristic parameters corresponding to the training data, and updating the neural network model by reflecting the image characteristic parameters in the neural network model.

### CROSS-REFERENCE TO RELATED APPLICATION(S)

This application is a bypass continuation application of International Application No. PCT/KR2024/004601, filed on Apr. 8, 2024, in the Korean Intellectual Property Receiving Office, which is based on and claims priority to Korean Patent Application No. 10-2023-0057489, filed on May 3, 2023, in the Korean Intellectual Property Office, the disclosures of which are incorporated by reference herein in their entireties

### BACKGROUND

The disclosure relates to a method for updating an object re-identification neural network model.

As algorithms for detecting persons and vehicles using artificial intelligence have advanced, neural network algorithms for person/vehicle re-identification (Re-ID) that utilize detection results are also being studied. A person or vehicle re-identification algorithm determines whether a person or a vehicle detected by a detection system correspond to the same individual or vehicle. Such algorithms are mainly used in surveillance systems such as closed-circuit television (CCTV) and, in particular, are employed in systems that deploy multiple cameras in places such as supermarkets, hospitals, and hotels to search for a target person.

To train a re-identification neural network, it is first necessary to construct a training dataset for the same persons or vehicles captured by multiple cameras, which entails costs for installing cameras, extracting data, and cleaning data. In addition, once the training dataset is completed, training and validating a neural network using the dataset may require several days to, at most, several months.

Further, a process is required to embed and deploy the trained person or vehicle re-identification neural network so that it can operate on an edge device.

The characteristics of images acquired can vary depending on the site and installation position of CCTV cameras. That is, the characteristics recognized in the images (e.g., brightness, background, degree of blur) may differ by installation site or camera. As such, each site or camera exhibits different characteristics, and to address this, data collected from the corresponding site and camera must be refined and used to train a re-identification model. In particular, creating trainable data may require time and cost to compose same-person image sets. In addition, costs are incurred for installing multiple cameras and for the time and labor needed to process the collected data. If images obtained through surveillance cameras installed at a new location exhibit characteristics different from conventional ones, there arises a problem of incurring costs and time to newly collect and refine data at that location and to perform training.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

To address the above-described problems, the disclosure aims to provide a method for updating a re-identification neural network so as to adapt to the image characteristics exhibited by respective surveillance camera devices.

The disclosure also aims to provide a method for efficiently updating a pre-trained re-identification neural network model without labeling training data and, further, without the need to compute a loss function.

The disclosure further aims to provide a method that enables efficient updating of the re-identification neural network model even in an edge device environment (surveillance camera device).

The technical problems to be addressed by the disclosure are not limited to those described above, and other technical problems not mentioned will be clearly understood by those skilled in the art from the following detailed description of the invention.

A surveillance camera device according to one or more embodiments may include: an image acquisition unit configured to acquire images; a memory storing a neural network model pre-trained for object re-identification; and a processor configured to objects from the images and obtain training data from among the objects for updating the neural network model according to a predetermined criterion; wherein the processor is further configured to input the training data to the neural network model in a feedforward manner to obtain image characteristic parameters corresponding to the training data, and to update the neural network model by reflecting the image characteristic parameters in the neural network model.

The processor may be configured to configure a batch normalization layer within the neural network model to normalize the image characteristic parameters, and update the image characteristic parameters by feeding the training data forward through a plurality of layers included in the neural network model.

The processor may be configured to update the image characteristic parameters by updating a mean and a variance of the training data and means and variances across the plurality of layers.

The predetermined criterion may include at least one of a size of a detection box of the object, a shape of the object, and a movement trajectory of the object. The image characteristic parameters may include at least one of edge variation, skewness, noise, an illumination component, and a reflectance component.

A first image used to train the pre-trained neural network model and a second image corresponding to the training data used to update the neural network model may be images acquired at different locations.

At least one of the image characteristic parameters of the first image and the second image may have different characteristics.

A method for updating a neural network model for object re-identification according to one or more embodiments may include: storing a neural network model pre-trained for object re-identification; acquiring images from a surveillance camera device; detecting objects from the images and, obtaining training data from among the objects to update the neural network model according to a predetermined criterion; and inputting the training data to the neural network model in a feedforward manner to obtain image characteristic parameters corresponding to the training data, and updating the neural network model by reflecting the image characteristic parameters in the neural network model.

The updating the neural network model may include: configuring, within the neural network model, a batch normalization layer to normalize the image characteristic parameters; and updating the image characteristic parameters by feeding the training data forward through a plurality of layers included in the neural network model.

The updating the image characteristic parameters may include updating a mean and a variance of the training data and a mean and a variance across the plurality of layers.

The method may further include transmitting the updated neural network model to the surveillance camera via a wireless communication unit.

The first image used to train the pre-trained neural network model and a second image corresponding to the training data used to update the neural network model may be images acquired through respective surveillance cameras installed at different locations.

A method for updating a neural network model for object re-identification according to one or more embodiments comprising: training a neural network model for object re-identification based on a first image acquired through a first camera installed at a first location; applying the trained neural network model to a second camera installed at a second location and acquiring a second image; obtaining training data to update the neural network model based on an object detected from the second image; and updating the neural network model based on image characteristic parameters of the second image obtained by inputting the training data to the neural network model in a feedforward manner.

The image characteristic parameters of the first image and the image characteristic parameters of the second image may differ in at least one element, and the image characteristic parameters may include at least one of edge variation, skewness, noise, an illumination component, and a reflectance component.

The first camera and the second camera may be respectively installed at positions having different viewpoints for a same object.

The method may further include: performing object re-identification in the second image with respect to a first object recognized in the first image; and based on the first object being recognized as a different object or a different object being recognized as the first object according to the re-identification, the obtaining training data to update the neural network model is performed.

The updating the neural network model may include: after acquiring the second image, performing object re-identification using the neural network model for object re-identification trained based on the first image; and based on a predetermined performance not being achieved as a result of the object re-identification, updating the neural network model.

According to one or more embodiments, a re-identification neural network model may be updated to adapt to image characteristics exhibited by respective surveillance camera devices.

According to one or more other embodiments, a pre-trained re-identification neural network model may be efficiently updated without labeling data and without computing a loss function.

According to yet one or more other embodiments, the re-identification neural network model may be efficiently updated even in an edge device environment (surveillance camera device).

The effects obtainable from the disclosure are not limited to those described above, and other effects not mentioned will be clearly understood by those skilled in the art from the following description.

### BRIEF DESCRIPTION OF DRAWINGS

The accompanying drawings, which are included as part of the detailed description to help the understanding of the disclosure, provide embodiments of the disclosure, and explain the technical features of the disclosure together with the detailed description.

FIG. 1 is a diagram for explaining a surveillance camera system for implementing an image processing method of a surveillance camera according to one or more embodiments.

FIG. 2 is a schematic block diagram of a surveillance camera according to one or more embodiments.

FIG. 3 is a diagram for explaining an AI device (module) applied to analysis of surveillance camera images according to one or more embodiments.

FIG. 4 is a flowchart of a method for updating a neural network model for object re-identification according to one or more embodiments.

FIG. 5 is a diagram for explaining a method for updating a neural network model according to one or more embodiments.

FIG. 6 is a flowchart for explaining another example of a method for updating a neural network model for object re-identification according to one or more embodiments.

The accompanying drawings included as part of the detailed description to facilitate understanding of the disclosure provide embodiments of the disclosure and describe technical features of the disclosure along with detailed descriptions.

### DESCRIPTION

Hereinafter, embodiments of the disclosure will be described in detail with reference to the attached drawings. All of these embodiments are non-limiting example embodiments, and thus, the disclosure is not limited thereto and may be realized in various other forms.

The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element.

When an element is “directly coupled” or “directly connected” to another element, it should be understood that no element is present between the two elements.

The singular forms are intended to include the plural forms as well, unless the context clearly indicates otherwise. As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

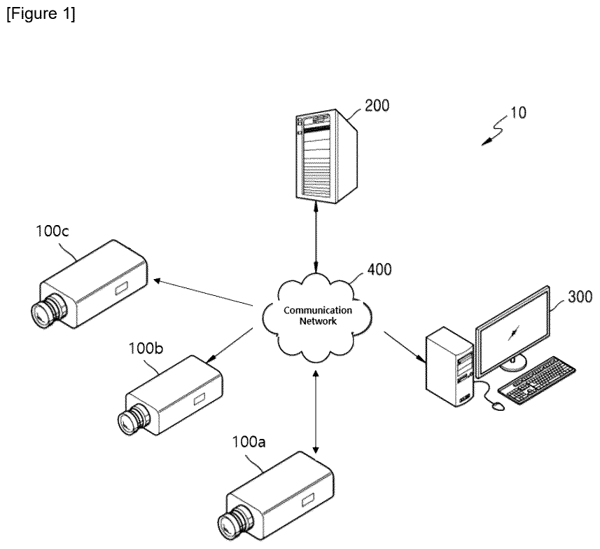

FIG. 1 is a diagram for explaining a surveillance camera system for implementing an image processing method of a surveillance camera according to one or more embodiments.

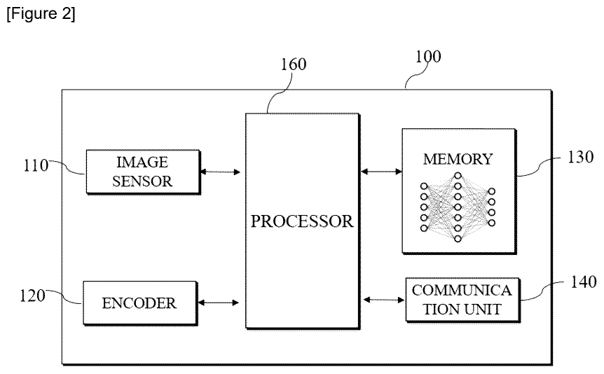

Referring to FIG. 1, an image management system 10 according to one or more embodiments may include imaging devices 100a, 100b, and 100c (hereinafter collectively referred to as “imaging device 100” for convenience, shown in FIG. 2) and an image management server 200. The imaging device 100 may be an electronic imaging device placed at a fixed position in a specific place, an electronic imaging device that can move automatically or manually along a predetermined route, or an electronic imaging device that can be moved by a person or a robot.

The imaging device 100 may be an Internet Protocol (IP) camera used in connection with wired or wireless Internet. The imaging device 100 may be a pan-tilt-zoom (PTZ) camera having pan, tilt, and zoom functions. The imaging device 100 may have a function of recording or photographing a monitored area. The imaging device 100 may have a function of recording sounds occurring in the monitored area. The imaging device 100 may generate a notification or perform recording or photographing when a change such as movement or sound occurs in the monitored area.

The imaging device 100 may be each or one of a plurality of imaging devices 100a, 100b, and 100c installed in different spaces. For example, a first imaging device 100a and a second imaging device 100b may be spaced apart by a first distance, and the second imaging device 100b and a third imaging device 100c may be spaced apart by a second distance. That is, each of the imaging devices 100a, 100b, and 100c may be implemented as a CCTV system arranged at positions where the same person can be imaged at predetermined time intervals.

The plurality of imaging devices 100a, 100b, and 100c may be devices that respectively collect image data for image management by a single image management server 200. Accordingly, even if the same object is included in respective images acquired by the plurality of imaging devices 100a, 100b, and 100c, the object may be recognized as different objects depending on illumination and background at the installation positions and on the viewpoints of the respective imaging devices. That is, after an object is detected by the first imaging device 100a, the object may be sequentially detected by the second imaging device 100b and the third imaging device 100c through object movement. The image management server 200 may perform an object re-identification operation to check whether the object is recognized as the same object also in the second imaging device 100b and the third imaging device 100c. As a result of the object re-identification operation, if the object is recognized as different objects in the first imaging device 100a, the second imaging device 100b, and the third imaging device 100c, it is necessary to update a neural network model for object re-identification included in the image management server 200 and/or in each imaging device 100a, 100b, and 100c.

The image management server 200 may be a device that receives, stores, and/or retrieves a video itself captured through the imaging device 100 and/or a video obtained by editing the captured video. The image management server 200 may analyze the received video according to an intended use. For example, the image management server 200 may detect objects by using an object detection algorithm to detect objects in the video. The object detection algorithm may be AI-based, and objects may be detected by applying a pre-trained artificial neural network model.

According to one or more embodiments, the image management server 200 may perform a function as an image search device. The image search device allows a user to quickly and easily search images obtained from a plurality of surveillance camera channels by inputting a specific image, an object included in a specific image, or a specific channel as a search condition. To enable easy searching by a user, the image search device requires a prior process of building a database, and one or more embodiments proposes a method of limiting a search target size according to specific search conditions to limit the computational load.

Meanwhile, the image management server 200 may be a network video recorder (NVR) or a digital video recorder (DVR) that stores videos obtained via a network. Alternatively, it may be a central management system (CMS) that integrally manages and controls videos to allow remote monitoring. However, the image management server 200 is not limited thereto and may be a personal computer or a portable terminal. These are merely examples, and the technical spirit of the disclosure is not limited thereto. Any device that can receive multimedia objects from one or more surveillance cameras over a network and display and/or store them may be used without limitation.

Meanwhile, the image management server 200 may store various trained models suited to the purpose of video analysis. In addition to trained models for object detection as described above, it may store a model capable of obtaining a movement speed of a detected object. Here, the trained models may include a model that, using as input, images captured through the plurality of imaging devices 100a, 100b, and 100c (i.e., images with different capture times and capture locations), outputs a person's gender and a feature vector value of the image.

In addition, the image management server 200 may analyze a received video to generate metadata and index information for the metadata. The image management server 200 may analyze image information included in the received video and/or audio information together or separately to generate metadata and index information for the metadata. The metadata may further include time information when the video was captured and information of capture location.

The image management system 10 may further include an external device 300 capable of performing wired or wireless communication with the imaging device 100 and/or the image management server 200.

The external device 300 may transmit an information provision request signal to the image management server 200 requesting provision of all or part of a video. The external device 300 may transmit an information provision request signal to the image management server 200 requesting, as analysis results of the video, presence or absence of an object, a movement speed of an object, a shutter speed control value according to the movement speed of an object, a noise reduction value according to the movement speed of an object, a sensor gain value, and the like. The external device 300 may also transmit an information provision request signal to the image management server 200 requesting metadata obtained by analyzing the video and/or index information for the metadata.

The image management system 10 may further include a communication network 400 serving as a wired or wireless communication path among the imaging device 100, the image management server 200, and/or the external device 300. The communication network 400 may encompass wired networks such as Local Area Networks (LANs)), Wide Area Networks (WANs), Metropolitan Area Networks (MANs), and Integrated Service Digital Networks (ISDNs), and wireless networks such as wireless LANs, Code-Division Multiple Access (CDMA) networks, Bluetooth, and satellite communication networks, but the scope of the disclosure is not limited thereto.

FIG. 2 is a schematic block diagram of a surveillance camera according to one or more embodiments.

FIG. 2 is a block diagram showing a configuration of the camera illustrated in FIG. 1. Referring to FIG. 2, a camera 100 is described by way of example as a network surveillance camera that performs intelligent video analysis to generate a video-analysis signal, but operation of the network surveillance camera system according to embodiments of the disclosure is not limited thereto.

The camera 100 includes an image sensor 110, an encoder 120, a memory 130, an event sensor 140, a processor 140, and a communication unit 150.

The image sensor 110 captures a monitored area to acquire images and may be implemented, for example, as a Charge-Coupled Device (CCD) sensor or a Complementary Metal-Oxide-Semiconductor (CMOS)) sensor.

The encoder 120 encodes an images acquired through the image sensor 110 into digital signals, following, for example, standards such as H.264, H.265, Moving Picture Experts Group (MPEG), and Motion Joint Photographic Experts Group (M-JPEG).

The memory 130 can store video data, audio data, still images, and metadata. As noted above, the metadata may include data such as object-detection information captured in a monitored area (movement, sound, intrusion into a designated region, etc.), object identification information (person, vehicle, face, hat, clothing, etc.), and detected location information (coordinates, size, etc.).

In addition, the still images are generated together with the metadata and stored in the memory 130, and may be created by capturing image information for a specific analysis region among the above video-analysis information. In one example, the still images may be implemented as JPEG image files.

In one example, the still images may be generated by cropping a specific region of video data (image) in the monitored area that has been determined to include an identifiable object among the video data detected in a specific region and during a specific period, and may be transmitted in real time together with the metadata.

The memory 130 may store a neural network model trained for object recognition. The neural network model may be configured and trained in consideration of brightness and variance, which are image-characteristic parameters. When a feature is extracted at each neural network layer, training may be performed in consideration of brightness and variance for the feature value. When neural network training is completed, the image-characteristic parameters determined according to the training data may be fixed and may not change. The neural network model may be received from the image management server 200 of FIG. 1 and stored in the memory 130 by the processor 160. Alternatively, the neural network model may be trained independently in the image capturing device 100 and stored in the memory 130.

According to one or more embodiments, the You Only Look Once (YOLO) algorithm may be applied to object detection. Because YOLO provides fast object detection, it is suitable for surveillance cameras that process real-time video. Unlike other object-based algorithms (such as Faster R-CNN, R-FCN, and FPN-FRCN), the YOLO algorithm resizes a single input image and passes it through a single neural network once to output bounding boxes indicating the positions of respective objects and classification probabilities indicating what the objects are. Finally, non-max suppression is used so that each object is detected once.

It is noted that the object recognition algorithm disclosed herein is not limited to the aforementioned YOLO and may be implemented using various deep-learning algorithms.

The communication unit 140 transmits the video data, audio data, still images, and/or metadata to a video receiving/search device (300 in FIG. 1). In one embodiment, the communication unit 140 can transmit the video data, audio data, still images, and/or metadata to the video receiving device (300 in FIG. 1) in real time. The communication unit 140 may perform at least one communication function among wired/wireless LAN, Wi-Fi, ZigBee, Bluetooth, and Near Field Communication (NFC).

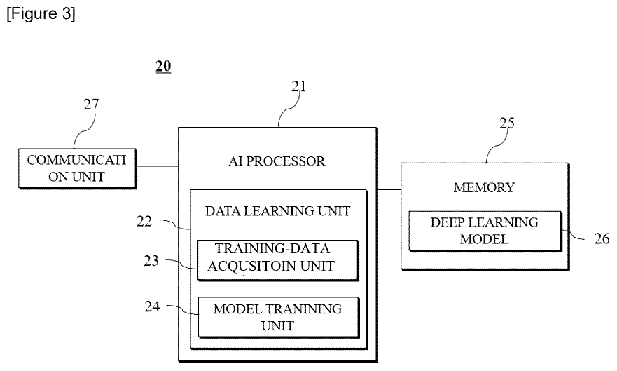

According to one or more embodiments, object recognition for images acquired through a surveillance camera and training of a neural network model for object recognition may be performed under control of the processor 160 shown in FIG. 2, but may also be performed by an AI device (module) provided independently for AI video analysis. For convenience of explanation, an AI device (module) is described in FIG. 3, but it goes without saying that the functions performed by the module of FIG. 3 may also be performed by the processor 160 of FIG. 2.

FIG. 3 is a diagram for explaining an AI device (module) applied to an image search device according to one or more embodiments.

Referring to FIG. 3, an AI device 20 may include an electronic device including an AI module capable of AI processing or a server including an AI module. The AI device 20 may also be provided as part of the configuration of a surveillance camera or an image management server to perform at least part of the AI processing together.

AI processing may include all operations related to a controller (processor) of the surveillance camera or the image management server. For example, the surveillance camera or the image management server may perform processing/judgment and control-signal generation by AI-processing the acquired video signal.

The AI device 20 may be a client device that directly uses AI processing results or a device in a cloud environment that provides AI processing results to another device. The AI device 20 is a computing device capable of training neural networks and may be implemented as various electronic devices such as a server, desktop PC, notebook PC, or tablet PC.

The AI device 20 may include an AI processor 21, a memory 25, and/or a communication unit 27.

The AI processor 21 may train a neural network using a program stored in the memory 25. In particular, the AI processor 21 may train a neural network for recognizing data related to a surveillance camera. Here, the neural network for recognizing data related to a surveillance camera may be designed to simulate the structure of the human brain on a computer and may include a plurality of network nodes with weights that simulate neurons of a human neural network. The plurality of network nodes may transmit and receive data according to connection relationships to simulate synaptic activity of neurons that exchange signals via synapses. The neural network may include a deep learning model evolved from a neural network model. In a deep learning model, the plurality of network nodes may be located in different layers and may transmit and receive data according to convolution connections. Examples of neural network models include various deep learning techniques such as deep neural networks (DNN), convolutional deep neural networks (CNN), recurrent neural networks (RNN, Recurrent Boltzmann Machine), restricted Boltzmann machines (RBM), deep belief networks (DBN), and deep Q-networks, and may be applied to fields such as computer vision, speech recognition, natural language processing, and audio/signal processing.

The processor performing the above functions may be a general-purpose processor (e.g., a CPU) or an AI-dedicated processor for artificial intelligence training (e.g., a GPU).

The memory 25 may store various programs and data necessary for operation of the AI device 20. The memory 25 may be implemented as nonvolatile memory, volatile memory, flash memory, a hard disk drive (HDD), or a solid-state drive (SSD). The memory 25 is accessed by the AI processor 21, and the AI processor 21 may perform reading/writing/modifying/deleting/updating of data. In addition, the memory 25 may store a neural network model (e.g., a deep learning model 26) generated through a learning algorithm for data classification/recognition according to one or more embodiments.

The AI processor 21 may include one or more processors including or implementing a data learning unit 22 for training a neural network for data classification/recognition. The data learning unit 22 may learn which training data to use to determine data classification/recognition and criteria for how to classify and recognize data using the training data. The data learning unit 22 may obtain training data to be used for learning and may train a deep learning model by applying the obtained training data to the deep learning model.

The data learning unit 22 may be manufactured in the form of at least one hardware chip and mounted on the AI device 20. For example, the data learning unit 22 may be manufactured as a dedicated hardware chip for artificial intelligence (AI) or may be manufactured as part of a general-purpose processor (CPU) or a graphics processor (GPU) and mounted on the AI device 20. The data learning unit 22 may also be implemented as a software module. When implemented as a software module (a program module including instructions), the software module may be stored in a non-transitory computer-readable recording medium such as the memory 25. In this case, at least one software module may be provided by an operating system (OS) or by an application.

The data learning unit 22 may include a training-data acquisition unit 23 and a model learning unit 24.

The training-data acquisition unit 23 may acquire training data required for a neural network model for data classification and recognition.

The model training unit 24 may train the neural network model so that it has criteria for how to classify predetermined data using the acquired training data. At this time, the model training unit 24 may train the neural network model through supervised learning that uses at least some of the training data as criteria. Alternatively, the model training unit 24 may train the neural network model through unsupervised learning that discovers criteria by learning autonomously using training data without supervision. In addition, the model training unit 24 may train the neural network model through reinforcement learning using feedback on whether the result of situation determination according to learning is correct. The model training unit 24 may also train the neural network model using a learning algorithm including an error back-propagation method or a gradient descent method.

When the neural network model is trained, the model training unit 24 may store the trained neural network model in the memory. The model training unit 24 may also store the trained neural network model in a memory of a server connected to the AI device 20 via a wired or wireless network.

The data learning unit 22 may further include a training-data preprocessor (not shown) and a training-data selector (not shown) to improve analysis results of the recognition model or to save resources or time necessary for generating the recognition model.

The training-data preprocessor may preprocess acquired data so that it can be used for learning for situation determination. For example, the training-data preprocessor may process acquired data into a preset format so that the model training unit 24 can use the acquired training data for learning for image recognition.

In addition, the training-data selector may select, from among the training data acquired by the training-data acquisition unit 23 or the training data preprocessed by the training-data preprocessor, data necessary for learning. The selected training data may be provided to the model training unit 24.

The data learning unit 22 may further include a model evaluator (not shown) to improve analysis results of the neural network model.

The model evaluator may input evaluation data to the neural network model and, if analysis results output from the evaluation data do not satisfy a predetermined criterion, may cause the model learning unit 22 to perform learning again. In this case, the evaluation data may be predefined data for evaluating a recognition model. For example, among analysis results of the trained recognition model for the evaluation data, if a number or ratio of evaluation data for which the analysis results are inaccurate exceeds a preset threshold, the model evaluator may evaluate that the predetermined criterion is not satisfied.

The communication unit 27 may transmit AI processing results by the AI processor 21 to an external electronic device. For example, the external electronic device may include a surveillance camera, a Bluetooth device, an autonomous vehicle, a robot, a drone, an Augmented Reality (AR) device, a mobile device, or a home appliance.

Although the AI device 20 shown in FIG. 3 has been described as being functionally divided into the AI processor 21, the memory 25, and the communication unit 27, it is noted that the above components may be integrated into a single module and referred to as an AI module.

The disclosure may be linked with one or more of a surveillance camera, an autonomous vehicle, a user terminal, and a server, and devices related to an Artificial Intelligence module, a robot, an Augmented Reality (AR) device, a Virtual Reality (VR) device, and 5G/6G services.

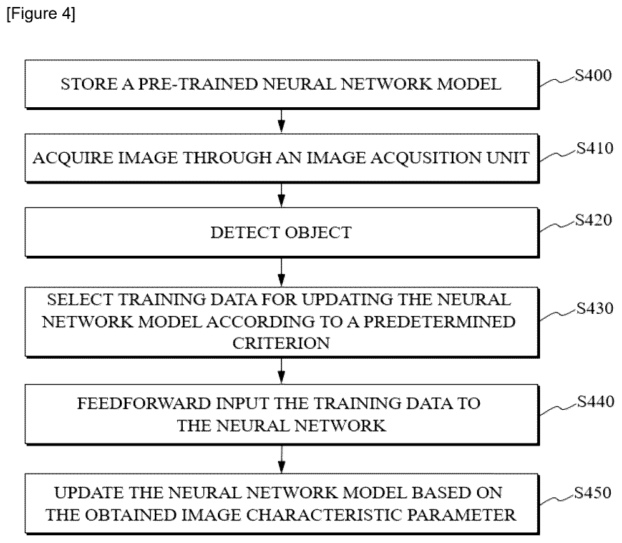

FIG. 4 is a flowchart of a method for updating a neural network model for object re-identification according to one or more embodiments. The neural network model update method of FIG. 4 can be implemented by a surveillance camera system, a surveillance camera device, and a processor or controller included in the surveillance camera device described with reference to FIGS. 1 to 3. Operations for updating a neural network model for object re-identification according to the disclosure may be performed solely by the surveillance camera device, or by a combination of the surveillance camera and the image management server. For convenience, FIG. 4 illustrates an implementation in a surveillance camera device (100a, 100b, 100c of FIG. 1; 100 of FIG. 2), and the case in which the operations are implemented by the processor 160 of the surveillance camera device is assumed for explanation.

Referring to FIG. 4, the surveillance camera 100 may store in a memory a pre-trained neural network model for object re-identification (S400).

Here, the neural network model, which may be or include an object recognition model and/or an object re-identification model, stored in the surveillance camera 100 may be the same as those stored in surveillance cameras installed at positions having different viewpoints. Different viewpoints may mean that objects recognized in images acquired by respective cameras for the same object are not recognized as the same object. For example, one camera may recognize a person's front, and another may recognize the person's back. In addition, because the image characteristic parameters of the acquired images differ between the two cameras, the probability of recognizing the same object as a different object is high.

According to one or more embodiments, a surveillance camera for which an update of the object re-identification model is required may be a surveillance camera newly installed at a particular place or site. Accordingly, if a previously trained re-identification model is applied as-is to a camera installed at the particular place or site, which is a new location to the camera, it may fail to reflect image characteristics acquired at the new location. To overcome this problem and to ensure reliability of object re-identification results, it is necessary to update the pre-trained and installed object re-identification model to match the locational characteristics where the camera is installed. To this end, images acquired at the new site need to be constructed as training data.

Accordingly, the processor 160 may acquire images through an image acquisition unit, which may include the image sensor 110, (S410) and may detect objects (S420). In one embodiment, the processor 160 may detect objects such as persons and vehicles in the images. The processor 160 may detect objects across a plurality of frames and analyze movement trajectories and shapes of the objects.

The processor 160 may select training data for updating the neural network model according to a predetermined criterion (S430). In one embodiment, the processor 160 may select, as training data for updating the neural network model, images of detected objects having large detection boxes and clear shapes. To update the re-identification neural network model according to one or more embodiments, adaptive learning may update the neural network model using only data collected at the newly installed site, without requiring the training data used for training the pre-trained neural network model.

By inputting the selected training data to the pre-trained neural network model in a feedforward manner (S440), the processor 160 may obtain image characteristic parameters of images collected at the new site. Because the disclosure enables model modification for the configured neural network model using only feedforward input without the need to compute a loss function, it can be applied efficiently even in an edge device environment where computational performance may be relatively low.

The processor 160 may update the neural network model based on the obtained image characteristic parameters(S450).

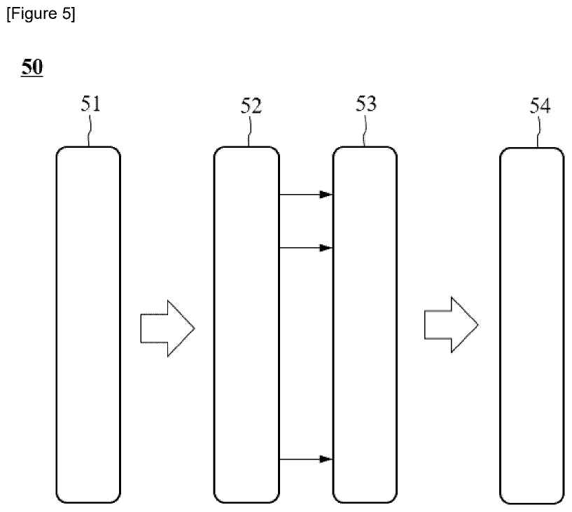

Hereinafter, with reference to FIG. 5, a process of efficiently updating a pre-trained neural network model using only a portion of newly acquired image data at a new site will be described in greater detail.

FIG. 5 is a diagram for explaining a method of updating a neural network model according to one or more embodiments.

Referring to FIG. 5, the processor 160 may configure a batch normalization layer 53 within a pre-trained neural network model to normalize image characteristic parameters, and may update the image characteristic parameters by feeding training data forward through a plurality of layers 51, 52, and 54 included in the neural network model.

Here, the image characteristic parameters may include at least one of edge variation, skewness, noise, an illumination component, and a reflectance component.

The method of reflecting the image characteristic parameters of images acquired by a surveillance camera installed at a new site is similar to a general batch normalization process.

Batch normalization refers to a technique in which one or more batch normalization layers are added to a neural network to normalize inputs to a layer based on statistical characteristics of the inputs derived from training data. Batch normalization may refer to a process of normalizing, on a batch basis, so that inputs have the same distribution even if the input data have various distributions.

A portion of a neural network 50 may include an input layer 51, a hidden layer 52, a batch normalization layer 53, and an output layer 54. During training, training data are generally divided into many “batches” for efficiency (for example, the entire training dataset may not fit in memory, and avoiding reads from disk or other mass storage can improve performance). Samples from each batch are provided to the input layer 51 of the neural network 50, and activations computed by each layer for a given input are supplied to the next layer. For example, activations computed by the input layer 51 are supplied as inputs to the hidden layer 52, which supplies its activations to the batch normalization layer 53. The batch normalization layer 53 normalizes the inputs received from the previous layer (e.g., the layer 52 shown in FIG. 5) for the current batch of training data. For example, the processor 160 may compute a mean and a variance of the inputs for the batch of training data and normalize the inputs so that they have the same mean and variance, and the normalized version of the inputs is then supplied to the next layer of the network (e.g., the layer 54 shown in FIG. 5). When training is completed, the means and the variances computed over the entire training dataset are stored in the batch normalization layer 53, so during inference the inputs to the batch normalization layer 53 are adjusted based on the mean and the variance of the training dataset.

Accordingly, each batch normalization layer of a pre-trained neural network model stores statistical characteristic information that reflects the statistical distribution of outputs of the previous layer in response to the training data (as processed through the previous layer of the neural network).

Meanwhile, in an object re-identification neural network method according to one or more embodiments, the mean and the variance parameters are not actually computed in advance over all training data, but are updated during training using methods such as moving averages or exponential averages. Not only the mean and the variance of the input data itself are considered, but also means and variances across layers of the neural network are computed and updated during training. In the inference stage after training is completed, the moving-mean and moving-variance parameters are fixed and no longer updated.

Accordingly, similarly to updating the mean and the variance parameters of a batch normalization layer, the disclosure may additionally configure a layer that can reflect values representing normalization of image characteristics, including the mean and the variance. Although the above description explains that a batch normalization layer is added to the re-identification neural network model, the disclosure is not limited thereto, and the additional layer may include any layer capable of performing batch-normalization functionality.

The image characteristics mentioned here may include edge variation, skewness, noise, an illumination component, and a reflectance component. Layers capable of normalizing such characteristics are configured, and image characteristic parameters for each layer are learned during training using methods such as moving averages or exponential averages. After training is completed, all parameters are fixed (frozen) for inference.

According to one or more embodiments, after installation at a new site, parameters for camera adaptation may be updated by updating the neural network model along the flow of FIG. 4. In one embodiment, the processor 160 first changes the image characteristic parameters to be trainable, while ensuring that parameters other than the image characteristic parameters are not changed. Thereafter, the processor 160 inputs training data to the re-identification neural network model. While data are fed forward inside the neural network, the image characteristic parameters are obtained and updated.

Accordingly, the disclosure enables updating of the neural network model using only data collected at the new site, without requiring the training data used in the conventional neural network model training process.

In addition, because there is no need to label the training data one by one, resources required for updating the neural network model (labor costs and work time) can be reduced.

As a result, training can be performed even with only hundreds of images, and because there is no computation of a loss function and no need for iterative updates, training can be performed even in an edge device environment (surveillance camera device).

Meanwhile, the re-identification neural network model update process disclosed in the disclosure may also be efficiently performed through a combination of an edge device environment and a cloud environment.

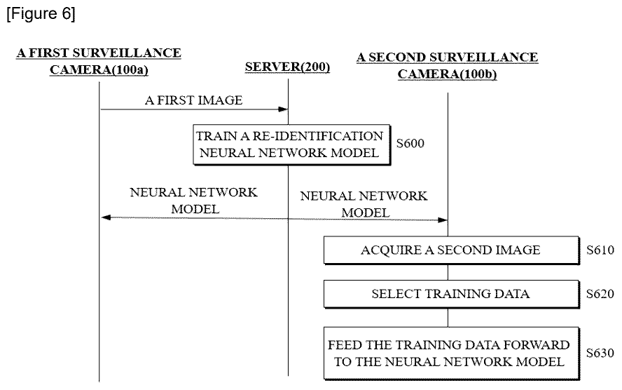

FIG. 6 is a flowchart for explaining another example of a method for updating a neural network model for object re-identification according to one or more embodiments.

Referring to FIG. 6, initial training of a re-identification neural network model may be performed by the server 200 based on a first image acquired from a first surveillance camera 100a (S600). The first surveillance camera 100a may be a surveillance camera installed at a specific place for a set period of time. A second surveillance camera may then be newly installed at a point in the same place that has a viewpoint different from that of the first surveillance camera.

The re-identification neural network model trained by the server 200 is provided to both the first surveillance camera 100a and the second surveillance camera 100b. Accordingly, the newly installed second surveillance camera 100b may initially perform object re-identification using the pre-trained re-identification neural network model. However, because the image characteristic parameters of images acquired by the first surveillance camera 100a and the second surveillance camera 100b may differ, the second surveillance camera 100b needs to further update the pre-trained neural network model based on the second image.

The second surveillance camera 100b acquires a second image (S610) and may select specific data among objects detected in the second image as training data (S620). As described above, the training data may be selected according to a predetermined criterion.

The second surveillance camera (100b) may feed the training data forward to the pre-trained neural network model(S630), thereby obtaining image characteristic parameters of the second image and efficiently updating the neural network model.

In one embodiment, although the second surveillance camera 100b is newly installed, if applying the pre-trained re-identification neural network model as-is poses no issue for reliability of object re-identification, the neural network model may be used without update. Accordingly, after installation at the new site, the second surveillance camera 100b may check the object re-identification results and update the neural network model based on the second image only when it is determined that the same object recognized by the first surveillance camera 100a has not been correctly recognized. That is, if, as a result of performing object re-identification on the second image acquired by the second surveillance camera 100b installed at the new site, a predetermined result is obtained—i.e., when the performance of the re-identification neural network model installed on the first surveillance camera is at or above a certain level—the pre-trained neural network model may not be updated using the image data acquired through the second image.

Although not shown in FIG. 6, after updating the neural network model for individual surveillance cameras, the server 200 may perform optimization to suit an edge-device environment and then provide the model to each surveillance camera.

As described above, while the disclosure provides a method of more easily updating a pre-trained and stored re-identification model through images acquired in an edge-device environment (a field-installed multi-surveillance camera system environment), the disclosure is not limited thereto. For example, even when the pre-trained and stored model is an object recognition model rather than an object re-identification model, the concepts derived herein may be applied. In one embodiment, with an object recognition model pre-trained and stored, model update may be performed by applying image data acquired in an edge environment to a pre-trained object recognition model, a face detection model, and the like.

The above embodiments can be implemented as computer-readable code recorded on a program-recorded medium. A computer-readable medium includes all types of recording devices in which data readable by a computer system are stored. Examples of computer-readable media include HDDs (hard disk drives), SSDs (solid-state drives), SDDs (silicon disk drives), ROM, RAM, CD-ROMs, magnetic tape, floppy disks, and optical data storage devices, and also include implementations in the form of carrier waves (e.g., transmission over the Internet). Accordingly, the above detailed description should not be construed as limiting in all respects, but should be considered illustrative. The scope of the disclosure should be determined by reasonable interpretation of the appended claims, and all modifications within the equivalent scope of the disclosure are included in the scope of the disclosure.

What is claimed is:

1. A camera device comprising:
an image acquisition unit configured to acquire images;
a memory storing a neural network model pre-trained for object re-identification; and
a processor configured to detect objects from the images and obtain training data from among the objects for updating the neural network model according to a predetermined criterion;
wherein the processor is further configured to input the training data to the neural network model in a feedforward manner to obtain image characteristic parameters corresponding to the training data, and to update the neural network model by reflecting the image characteristic parameters in the neural network model.

2. The camera device of claim 1, wherein the processor is configured to configure a batch normalization layer within the neural network model to normalize the image characteristic parameters, and update the image characteristic parameters by feeding the training data forward through a plurality of layers included in the neural network model.

3. The camera device of claim 2, wherein the processor is configured to update the image characteristic parameters by updating a mean and a variance of the training data and a mean and a variance across the plurality of layers.

4. The camera device of claim 1, wherein the predetermined criterion comprises at least one of a size of a detection box of an object, a shape of the object, and a movement trajectory of the object.

5. The camera device of claim 1, wherein the image characteristic parameters comprise at least one of edge variation, skewness, noise, an illumination component, and a reflectance component.

6. The camera device of claim 1, wherein a first image used to train the pre-trained neural network model and a second image corresponding to the training data used to update the neural network model are images acquired at different locations.

7. The camera device of claim 6, wherein at least one of the image characteristic parameters of the first image is different from a corresponding one of the image characteristic parameters of the second image.

8. A method for updating a neural network model for object re-identification, comprising:
storing a neural network model pre-trained for object re-identification;
acquiring images from a camera device;
detecting objects from the images and,
obtaining training data from among the objects to update the neural network model according to a predetermined criterion; and
inputting the training data to the neural network model in a feedforward manner to obtain image characteristic parameters corresponding to the training data, and updating the neural network model by reflecting the image characteristic parameters in the neural network model.

9. The method of claim 8, wherein the updating the neural network model comprises:
configuring, within the neural network model, a batch normalization layer to normalize the image characteristic parameters; and
updating the image characteristic parameters by feeding the training data forward through a plurality of layers included in the neural network model.

10. The method of claim 9, wherein the updating the image characteristic parameters comprises updating a mean and a variance of the training data and a mean and a variance across the plurality of layers.

11. The method of claim 8, further comprising transmitting the updated neural network model to the camera via a wireless communication unit.

12. The method of claim 8, wherein a first image used to train the pre-trained neural network model and a second image corresponding to the training data used to update the neural network model are images acquired through respective cameras installed at different locations.

13. A method for updating a neural network model for object re-identification, comprising:
training a neural network model for object re-identification based on a first image acquired through a first camera installed at a first location;
applying the neural network model to a second camera installed at a second location and acquiring a second image;
obtaining training data to update the neural network model based on an object detected from the second image; and
updating the neural network model based on image characteristic parameters of the second image obtained by inputting the training data to the neural network model in a feedforward manner.

14. The method of claim 12, wherein at least one of the image characteristic parameters of the first image is different from a corresponding one of the image characteristic parameters of the second image, and the image characteristic parameters comprise at least one of edge variation, skewness, noise, an illumination component, and a reflectance component.

15. The method of claim 12, wherein the first camera and the second camera are respectively installed at positions having different viewpoints for a same object.

16. The method of claim 12, further comprising:
performing object re-identification in the second image with respect to a first object recognized in the first image; and
based on the first object being recognized as a different object or a different object being recognized as the first object according to the re-identification, the obtaining training data to update the neural network model is performed.

17. The method of claim 12, wherein the updating the neural network model comprises:
after acquiring the second image, performing object re-identification using the neural network model for object re-identification trained based on the first image; and
based on a predetermined performance not being achieved as a result of the object re-identification, updating the neural network model.
